(19) United States
(12) Patent Application Publication
(10) Pub. No.: US 2013/0214184 A1
(43) Pub. Date: Aug. 22, 2013

(54) FLUID TRANSPORT APPARATUS, REPLACEMENT UNIT AND METHOD FOR MANUFACTURING REPLACEMENT UNIT

(71) Applicant: Seiko Epson Corporation, (US)

(72) Inventor: Hajime MIYAZAKI, Matsumoto-shi (JP)

(73) Assignee: SEIKO EPSON CORPORATION, Tokyo (JP)

(21) Appl. No.: 13/765,392

(22) Filed: Feb. 12, 2013

(30) Foreign Application Priority Data
Feb. 17, 2012 (JP) 2012-032461

(51) Int. Cl. F16K 7/00

(52) U.S. Cl. CPC F16K 7/00
USPC 251/4; 29/890.12

(57) ABSTRACT

A fluid transport apparatus includes a main unit and a replacement unit that can be removably attached to the main unit. The replacement unit includes a tube for transporting a fluid, and a plurality of fingers for pressing against and occluding the tube, the plurality of fingers being arranged along the tube. The main unit includes a cam for pressing the plurality of fingers successively in a transport direction of the fluid. The tube, the plurality of fingers and the cam are arranged in a layered arrangement along a rotation axis direction of the cam.

### BACKGROUND

1. Technical Field

The present invention relates to fluid transport apparatuses, replacement units and methods for manufacturing a replacement unit.

2. Related Art

As one example of a fluid transport apparatus, a peristaltic pump is known that includes a tube guided into a circular arc shape, a cam that rotates with the center of the circular arc as the rotation axis, and a plurality of pressers (fingers) (see, for example, Japanese Patent No. 3,957,322 or JP-A-2009-216080). In such a fluid transport apparatus, as the cam is rotated, the cam successively presses against the plurality of fingers, which in turn occludes the tube in an advancing manner, whereby the fluid within the tube is transported.

Japanese Patent No. 3,957,322 and JP-A-2009-216080 are examples of related art.

In the fluid transport apparatuses of Japanese Patent No. 3,957,322 or JP-A-2009-216080, the cam and the tube that is guided in a circular arc shape are arranged on the same plane, and the plurality of fingers for pressing against the tube are arranged radially on the same plane. More specifically, the fingers are arranged on an outer circumference of the cam, and the tube is guided in a circular arc shape further outward from the fingers. As a result, the footprint (planar size) of the fluid transport apparatus becomes large, and it is difficult to make the apparatus compact.

### SUMMARY

It is an object of the invention to make the apparatus more compact.

In order to achieve this object, according to one aspect of the invention, a fluid transport apparatus includes a main unit and a replacement unit that can be removably attached to the main unit. The replacement unit includes a tube for transporting a fluid, and a plurality of fingers for pressing against and occluding the tube, the plurality of fingers being arranged along the tube. The main unit includes a cam for pressing the plurality of fingers successively in a transport direction of the fluid. The tube, the plurality of fingers and the cam are arranged in a layered arrangement along a rotation axis direction of the cam.

Other features of the invention will become clear from the following description and the accompanying drawings.

### BRIEF DESCRIPTION OF THE DRAWINGS

FIG. 1 is a diagram illustrating the arrangement of a tube 11, fingers 12 and a cam 21 according to a first embodiment, taken from above.

FIG. 2 is a diagram illustrating the shape of the cam 21 of the first embodiment.

FIG. 3 is a diagram illustrating the motion of the fingers 12.

FIG. 4 is a diagram illustrating how the replacement unit 10 of the first embodiment is mounted.

FIG. 5A is a diagram illustrating the arrangement of a motor 24. FIG. 5B is a diagram illustrating another arrangement of the motor 24.

FIG. 6 is a diagram illustrating the arrangement of a cam 21, a tube 11 and fingers 12 according to a second embodiment, taken from above.

FIG. 7 is a diagram illustrating the shape of the cam 21 of the second embodiment.

FIG. 8 is a diagram illustrating the motion of the fingers 12.

FIG. 9 is a diagram illustrating the arrangement of a tube, fingers and a cam according to a comparative example.

FIG. 10 is a diagram illustrating how a replacement unit according to a comparative example is mounted.

### DESCRIPTION OF EXEMPLARY EMBODIMENTS

At least the following aspects should become clear from the present specification and the accompanying drawings.

A fluid transport apparatus is disclosed that includes a main unit and a replacement unit that can be removably attached to the main unit. The replacement unit includes a tube for transporting a fluid, and a plurality of fingers for pressing against and occluding the tube, the plurality of fingers being arranged along the tube. The main unit includes a cam for pressing the plurality of fingers successively in a transport direction of the fluid. The tube, the plurality of fingers and the cam are arranged in a layered arrangement along a rotation axis direction of the cam.

With such a fluid transport apparatus, the apparatus can be made more compact.

It is preferable that the fingers are supported movably along a direction in which the replacement unit is mounted to the main unit. Thus, damage to the fingers can be prevented.

It is preferable that the tube is not occluded before the main unit is mounted, and when being mounted to the main unit, at least one of the fingers is pushed by the cam and occludes the tube. In this case, it is particularly effective if the fingers are supported movably in the mounting direction.

It is preferable that the main unit is provided with a motor for driving the cam. Thus, the replacement unit can be configured inexpensively.

It is preferable that the replacement unit is provided with a motor for driving the cam. Thus, the motor can be replaced if durability of the motor cannot be expected.

Also disclosed is a replacement unit of a fluid transport apparatus, the replacement unit including a tube for transporting a fluid, and a plurality of fingers for pressing against and occluding the tube, the plurality of fingers being arranged along the tube. The replacement unit can be removably attached to a main unit including a cam for pressing the plurality of fingers successively in a transport direction of the fluid. The tube and the plurality of fingers are arranged in a layered arrangement along a rotation axis direction of the cam.

With such a replacement unit, the apparatus can be made more compact.

It is preferable that a method for manufacturing the replacement unit includes the following steps: preparing fingers of different lengths, selecting fingers of a length corresponding to a diameter of the tube, and using the fingers of the selected length to manufacture the replacement unit. Thus, the length of the fingers can be easily adjusted.

### Comparative Example

In order to facilitate the understanding of the fluid transport apparatus according to the present embodiment, a fluid transport apparatus according to a comparative example is explained prior to explaining the fluid transport apparatus of the present embodiment.

### Apparatus According to Comparative Example

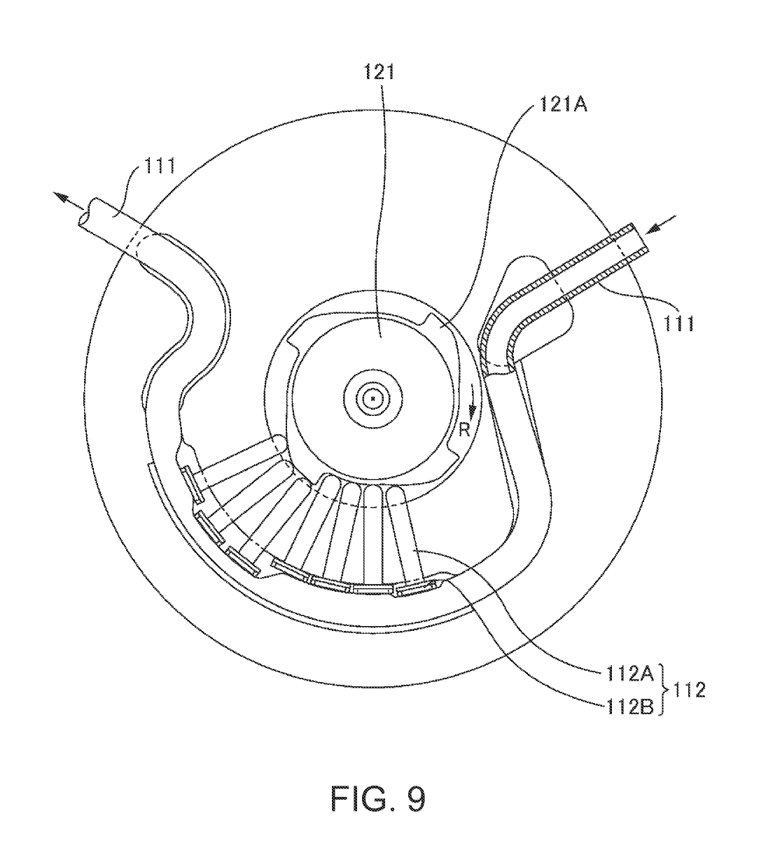

FIG. 9 is a diagram illustrating the arrangement of a tube 111, fingers 112 and a cam 121 according to the comparative example.

The tube 111 is arranged partially in the shape of a circular arc along the inner surface of a circular arc-shaped tube-guiding wall. The center of the circular arc of the tube 111 coincides with the rotation center of the cam 121.

The fingers 112 are supported such that their axial portions 112A are movable along their axial direction. A pressing portion 112B is formed on the tube side at the end of each of the axial portions. The ends of the axial portions on the cam side have a semi-spherical shape and are in contact with the cam.

The plurality of fingers 112 are arranged at equal distances radially from the rotation axis of the cam 121. The plurality of fingers 112 are arranged between the outer circumferential surface of the cam 121 and the tube 111.

The cam 121 includes protrusions 121A on its outer circumference. The plurality of fingers 112 are arranged at the outer circumference of the cam 121, and the tube 111 is arranged to the outer side of the fingers 112. The tube 111 is occluded by the fingers 112 as the fingers are pushed by the protrusions 121A of the cam 121. When the fingers 112 are released from the protrusions 121A, the tube 111 is restored to its original shape due to the elasticity of the tube 111. When the cam 121 rotates, the seven fingers 112 are pressed successively by the protrusions 121A, thus closing the tube 111 progressively from the upstream side in transport direction. Thus, the tube undergoes a peristaltic motion and the fluid is compressed and transported through the tube 111.

In this comparative example, the cam 121 and the tube 111, which is guided in a circular arc shape, are arranged on the same plane, and also the plurality of fingers 112 are arranged radially on the same plane. That is to say, in the comparative example, the fingers 112 are arranged on the outer circumference of the cam 121, and the tube 111 is guided in a circular arc shape further outward from the fingers 112. As a result, the footprint of the fluid transport apparatus becomes large, and it is difficult to make the apparatus compact.

### How the Comparative Example is Mounted

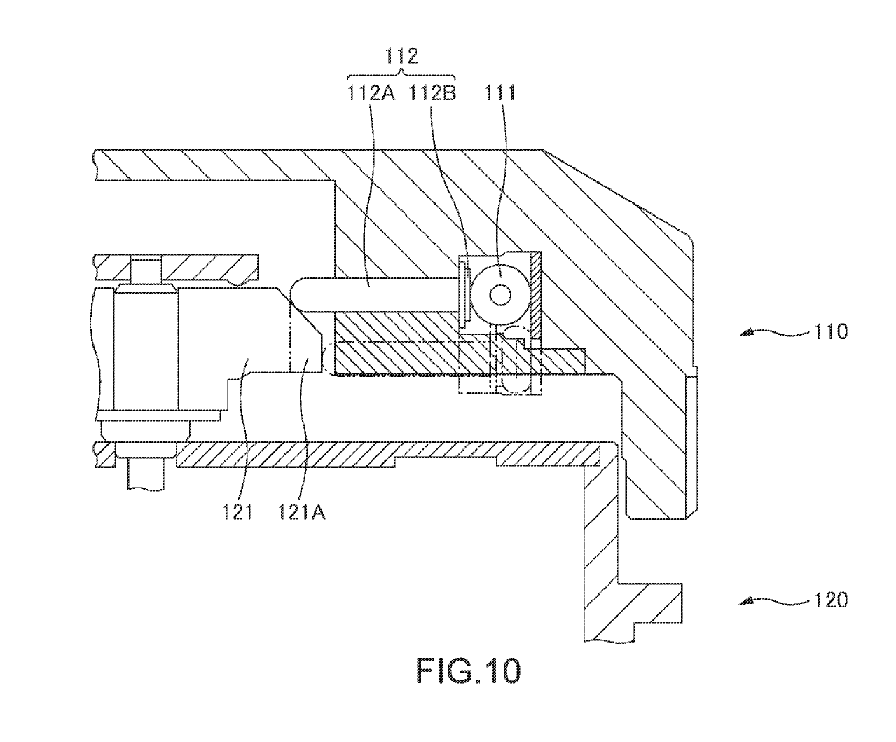

FIG. 10 is a diagram illustrating how a replacement unit 110 according to the comparative example is mounted. The replacement unit 110 is mounted to the main unit 120 from the top downward. This mounting direction is a direction parallel to the rotation axis of the cam 121.

The fingers 112 of the comparative example are supported movably in a direction that is perpendicular to the rotation axis of the cam 121 (planar direction), such that when they are subjected to a force from the outer circumferential surface of the cam 121, they can be pressed against the tube 111, and are confined in the mounting direction (the direction parallel to the rotation axis of the cam 121). When one end of the axial portions 112A of the fingers 112 contacts the projections 121A of the cam 121 during the mounting of the replacement unit 110, even though the fingers 112 are confined in the mounting direction, one end of the axial portions 112A is subjected to an upward-directed force, so that there is the risk of damage to the axial portions 112A.

### First Embodiment

### Overall Arrangement

In the following explanations, the direction parallel to the rotation shaft 22 of the cam 21 is referred to as “vertical direction” or “rotation axis direction”. Moreover, the side of the replacement unit 10 seen from the main unit 20 is referred to as “above” and its opposite side is referred to as “below”. Moreover, directions perpendicular to the rotation shaft 22 of the cam 21 are referred to as “planar direction”.

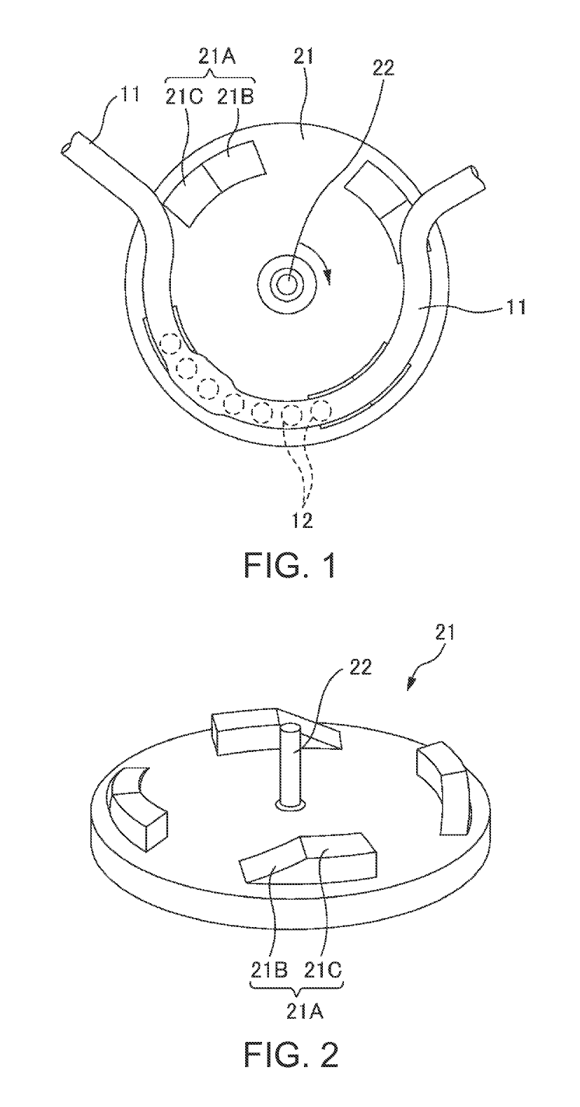

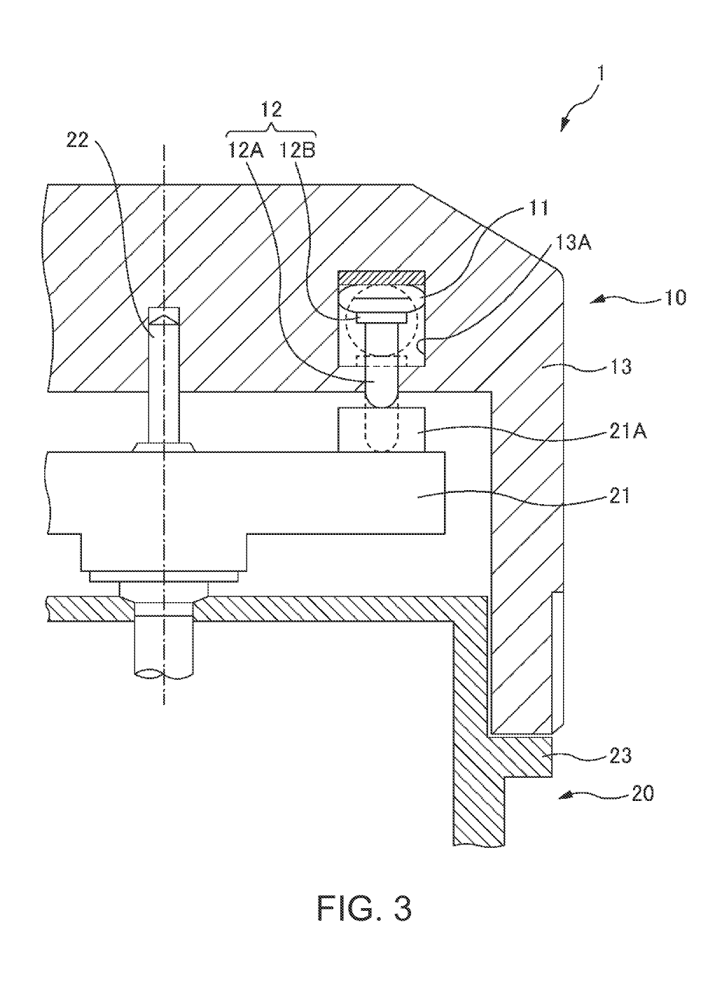

FIG. 1 is a diagram illustrating the arrangement of a tube 11, fingers 12 and a cam 21 according to the first embodiment, taken from above. FIG. 2 is a diagram illustrating the shape of the cam 21 of the first embodiment. FIG. 3 is a diagram illustrating the motion of the fingers 12.

The fluid transport apparatus 1 is for transporting a fluid. The fluid transport apparatus 1 includes the tube 11, the plurality of fingers 12 and the cam 21. As shown in FIG. 3, the tube 11 and the fingers 12 are accommodated in a replacement frame 13 of the replacement unit 10. The cam 21 is provided on a main unit frame 23 of the main unit 20. It should be noted that the cam 21 is not accommodated within the main unit frame 23, but is exposed on the side of the replacement unit 10.

The tube 11 is a tube for transporting the fluid. The tube 11 is occluded when the fingers 12 press against it, and it has a certain elasticity that restores it when the force from the fingers 12 is released. The tube 11 is arranged partially in a circular arc shape along the inner surface of a circular arc-shaped tube-guiding path 13A that is formed in the replacement frame 13. The circular arc-shaped portion of the tube 11 is arranged between the upper surface of the tube-guiding path 13A and a pressing portion 12B (upper end of the fingers 12) of the plurality of fingers 12. The circular arc-shaped portion of the tube 11 is positioned above the fingers 12 and when the fingers 12 are pressed upward, the tube 11 is occluded by the fingers 12. The center of the circular arc of the tube 11 (and the tube-guiding path 13A) coincides with the rotation center of the cam 21.

One end of the tube 11 is in communication with a reservoir (not shown in the figures). The reservoir is a container for containing the fluid to be transported. For example, the reservoir may contain a liquid medicine. However, the fluid accommodated in the reservoir is not limited to liquid medicines, and it may also be any other liquid (for example, water, saline solution, liquid medicine, oil, liquid fragrance, ink or the like). Moreover, it is not necessarily a liquid and may also be a gas.

The fingers 12 are pressers for occluding the tube 11. When the fingers 12 are subjected to a force from the cam 21, they undergo a follower motion. The fingers 12 each include a rod-shaped axial portion 12A and a brim-shaped pressing portion 12B, and are T-shaped. The axial portions 12A of the fingers 12 are movable along the axial direction, and the fingers 12 are supported by the replacement frame 13. At the ends of the axial portions 12A on the side of the tube 11, the pressing portions 12B are formed. The pressing portions 12B are in contact with the tube 11. The ends of the axial portions 12A on the side of the cam 21 are provided with a semi-spherical shape and are in contact with the cam 21. The fingers 12 are made of a metal material or of a resinous material with high rigidity, but may also be made of another material.

The fingers 12 are arranged such that the axial portions 12A extend in the vertical direction (the rotation axis direction of the cam 21). The plurality of fingers 12 (here, the seven fingers 12) are arranged at equal distances on a circular arc, such that the distance from the axial portions 12A of the fingers 12 to the rotation shaft 22 of the cam 21 is the same. The fingers 12 are arranged below the tube 11. In FIG. 1, the fingers 12 are hidden below the tube 11, and the position of the fingers 12 is shown by dashed lines. The fingers 12 are arranged above the cam 21. In other words, the fingers 12 are arranged between the cam 21 and the tube 11.

The fingers 12 of the above-described comparative example are arranged on the outer circumference of the cam 21, whereas the fingers 12 of the present embodiment are arranged above the cam 21. Moreover, the fingers 12 of the above-described comparative example extend radially from the rotation shaft 22 of the cam 21, and the axial direction of the axial portions 12A of the fingers 12 is a planar direction (the direction perpendicular to the rotation shaft 22 of the cam 21). By contrast, the fingers 12 of the present embodiment are arranged in a circular arc shape along the tube 11, with the axial portions 12A extending parallel to the rotation axis direction of the cam 21. Moreover, the fingers 12 of the comparative example are movable in the planar direction (the direction perpendicular to the rotation shaft 22 of the cam 21), whereas the fingers 12 of the present embodiment are movable in the rotation axis direction of the cam 21.

The cam 21 is a component for pressing the fingers 12 successively against the tube 11 while rotating. The cam 21 of the first embodiment includes four protrusions 21A on an upper surface of a disk-shaped plate member. The protrusions 21A are for pressing the fingers 12 upwards. The four protrusions 21A all have the same shape. As the fingers 12 are pushed upward by the protrusions 21A of the cam 21, the tube 11 is occluded by the fingers 12. When the fingers 12 are removed from the protrusions 21A, the tube 11 is restored to its original shape due to the elasticity of the tube 11, and the fingers 12 descend downward. When the cam 21 rotates, the seven fingers 12 are pushed upwards successively by the protrusions 21A and the tube 11 is occluded progressively from the upstream side in transport direction. Thus, the tube 11 undergoes a peristaltic motion, and the fluid is compressed and transported through the tube 11. In order to prevent backflow of the fluid, the four protrusions 21A are shaped such that at least one, preferably two fingers 12 occlude the tube 11.

The protrusions 21A each include an oblique surface 21B and a horizontal surface 21C (see FIG. 2). The oblique surface 21B is positioned on the downstream side in rotation direction (transport direction) of the cam 21 with respect to the horizontal surface 21C. Therefore, when the cam 21 rotates, the oblique surface 21B comes into contact with the end of the axial portions 12A of the fingers 12 before the horizontal surface 21C, and the fingers 12 are lifted up little by little. The tube 11 continues to be occluded as long as the horizontal surface 21C is in contact with the fingers 12. When the cam 21 is rotated further and the fingers 12 are removed from the horizontal surface 21C of the protrusions 21A, the fingers 12 descend downward and the tube 11 is restored to its original shape.

With the present embodiment, the fingers 12 are arranged above the cam 21, and the tube 11 is arranged above the fingers 12 (whereas in the comparative example, the protrusions 21A are provided on the outer circumference of the cam 21, the fingers 12 are arranged outward of the cam 21, and the tube 11 is arranged outward of the fingers 12). By arranging the tube 11, the fingers 12 and the cam 21 in a layered arrangement in the rotation axis direction of the cam 21 (the direction in which the replacement unit 10 is mounted to the main unit 20), as in the present embodiment, the footprint (the dimensions in planar direction, in particular the dimensions in the radial direction around the rotation shaft 22 of the cam 21) can be reduced.

### About the Reason why the Fingers are Arranged on the Side of the Replacement Unit

Since the tube 11 is pressed together by the fingers 12, it may easily deteriorate and use over long periods of time is difficult. Accordingly, the tube 11 is arranged on the side of the replacement unit 10 and the tube 11 is made replaceable.

There are large variations in the diameter of the tube 11. Therefore, when the tube 11 is exchanged, there may be a change in the diameter of the tube 11. When there is a change in the diameter of the tube 11, the pressing amount when the fingers 12 press against the tube 11 changes, and there is the risk that the precision of the transport amount of the fluid will decrease. Accordingly, in the present embodiment, it is possible to adjust the length of the fingers 12 in accordance with the diameter of the tube 11 by configuring the replacement unit 10 such that the tube 11 and the fingers 12 are provided integrally.

When the replacement unit 10 is manufactured, three kinds of fingers 12 of different lengths (fingers 12 with a standard length, fingers 12 that are longer than the standard length, and fingers 12 that are shorter than the standard length) are prepared in advance. If the diameter of the tube 11 accommodated in a given replacement unit 10 is within a standard range, then the fingers 12 of the standard length are accommodated in that replacement unit 10. If the diameter of the tube 11 is smaller than the standard range, then the fingers 12 that are longer than the standard length are accommodated in the replacement unit 10. And if the diameter of the tube 11 is larger than the standard range, then the fingers 12 that are shorter than the standard length are accommodated in the replacement unit 10. Thus, the adjustment of the lengths of the fingers 12 is easy, because it is sufficient that fingers 12 of different lengths are prepared in advance and, of those, the fingers 12 matching the diameter of the tube 11 are selected.

By adjusting the lengths of the fingers 12 to match the diameter of the tube 11, the pressing amount when the fingers 12 press against the tube 11 is adjusted, and the transport amount of the fluid is adjusted. As a result, the precision of the transport amount of the fluid is improved. Moreover, the pressing amount when the fingers 12 press against the tube 11 is stabilized to a predetermined range, so that also the load (torque) for rotating the cam 21 settles within a predetermined range, and overloads acting on the motor 24 driving the cam 21 can be prevented.

### Mounting State

If the fingers 12 are arranged on the side of the replacement unit 10, there is the problem that fingers 12 may be damaged during the mounting, as in the comparative example. However, in the present embodiment, the movable direction of the fingers 12 differs from that of the comparative example, so that this problem does not occur. This aspect is explained in the following.

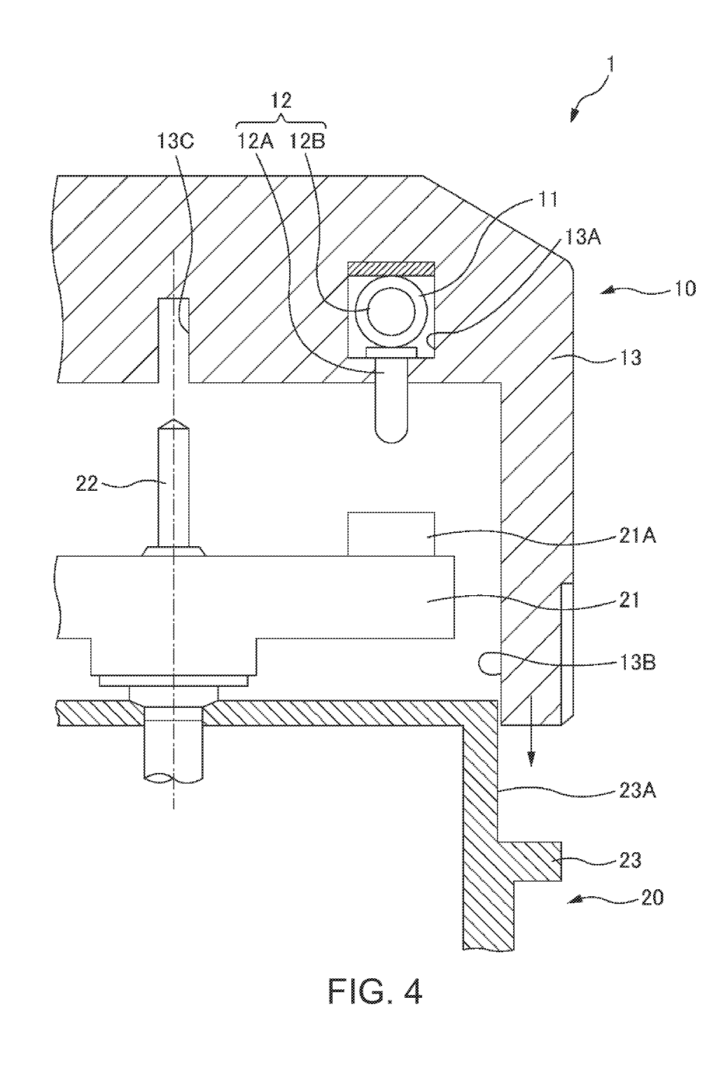

FIG. 4 is a diagram illustrating how the replacement unit 10 of the first embodiment is mounted. The replacement unit 10 is mounted to the main unit 20 from the top downward. This mounting direction is parallel to the rotation axis direction of the cam 21. The tube 11 of the replacement unit 10 is not occluded prior to mounting, and the fingers 12 are pushed downward by the tube 11.

When the replacement unit 10 is mounted to the main unit 20, first, a guide surface 13B (inner circumferential surface) of the replacement frame 13 is guided in the rotation axis direction (vertical direction) of the cam 21 by an outer circumferential surface 23A of the main unit frame 23. At this stage, movement in the planar direction of the replacement unit 10 is limited.

When the replacement unit 10 is brought closer to the main unit 20, the rotation shaft 22 of the cam 21 is inserted into a shaft hole 13C of the replacement frame 13. Before the rotation shaft 22 of the cam 21 is inserted into the shaft hole 13C, the movement of the replacement unit 10 in planar direction is limited, so that the rotation shaft 22 of the cam 21 will not be subjected to an undue force in planar direction from the shaft hole 13C, and there is no risk of damaging the rotation shaft 22 of the cam 21.

After this, when the replacement unit 10 is brought even closer to the main unit 20, the ends of the axial portions 12A of the fingers 12 come in contact with the cam 21. Since the protrusions 21A of the cam 21 are configured such that the tube 11 is occluded by at least one finger 12, so as to prevent back flow, at least one of the fingers 12 contacts the protrusions 21A when mounting the replacement unit 10. In this situation, those fingers 12 are subject to an upward force. Since the fingers 12 are supported movably in the vertical direction, even if the fingers 12 are subjected to an upward force by the upper surface of the cam 21 or the protrusions 21A during mounting, the fingers 12 can move upward and will not be damaged (by contrast, in the comparative example, the fingers 12 are confined in vertical direction, so that when the fingers 12 are subjected to an upward force by the cam 21 during mounting, there is the risk that the fingers 12 are damaged).

After the replacement unit 10 has been mounted to the main unit 20, the replacement frame 13 and the main unit frame 23 are fixed to one another with fixing means (not shown in the figures), such as screws.

### Arrangement of Motor Etc.

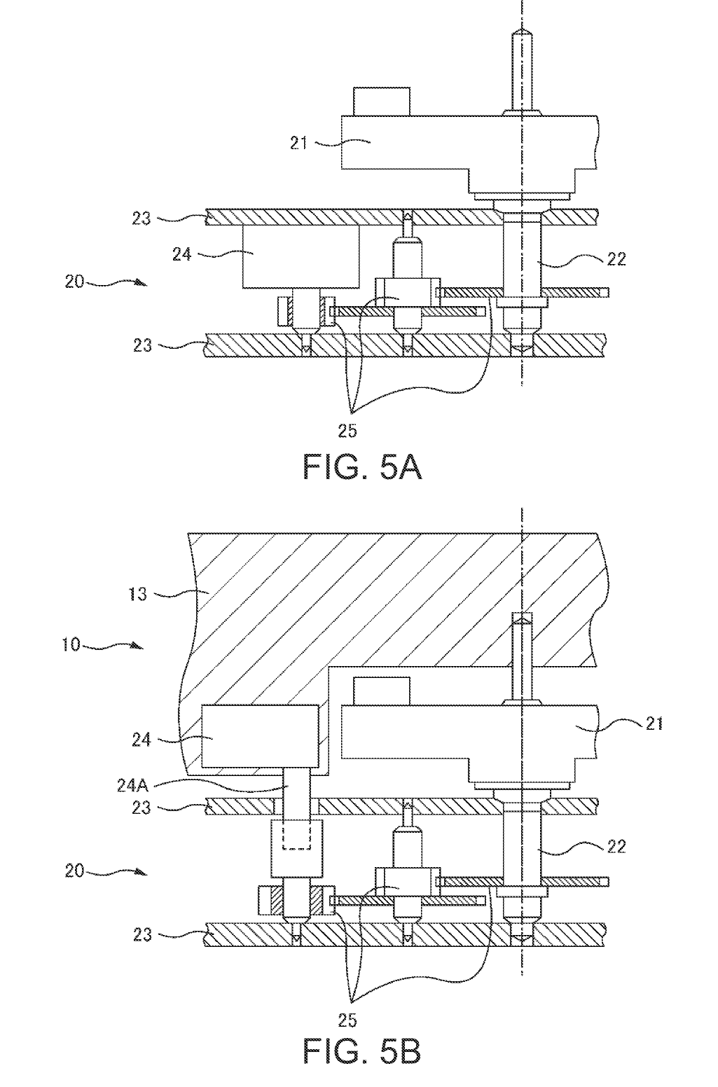

FIG. 5A is a diagram illustrating the arrangement of a motor 24. Here, the motor 24 for driving the cam 21 is accommodated in the main unit frame 23 of the main unit 20. In the main unit frame 23 of the main unit 20, a driving force transmitting mechanism 25 and a control portion (not shown in the figures) are provided together with the motor 24. The driving force transmitting mechanism 25 gears down the driving force of the motor 24 and transmits it to the rotation shaft 22 of the cam 21. The control portion (not shown in the figures) is a controller for controlling the motor.

FIG. 5B is a diagram illustrating another arrangement of the motor 24. Here, the motor 24 is provided on the side of the replacement unit 10. When the replacement unit 10 is mounted to the main unit 20, a drive shaft 24A of the motor 24 is inserted into the main unit frame 23 of the main unit 20, and the drive shaft 24A meshes with the driving force transmitting mechanism 25 provided in the main unit 20. Thus, the driving force transmitting mechanism 25 transmits a driving force from the motor 24 of the replacement unit 10 to the rotation shaft 22 of the cam 21.

If the motor 24 has durability, then it is preferable to configure the replacement unit 10 inexpensively by providing the motor 24 in the main unit 20, as in FIG. 5A. However, if the fluid transport apparatus 1 is mounted to a living organism, then an extremely small motor 24 may be used, and it may not be possible to ensure its durability. In such cases, if no sufficient durability of the motor 24 can be expected, the motor 24 may be provided in the replacement unit 10, as shown in FIG. 5B.

### Second Embodiment

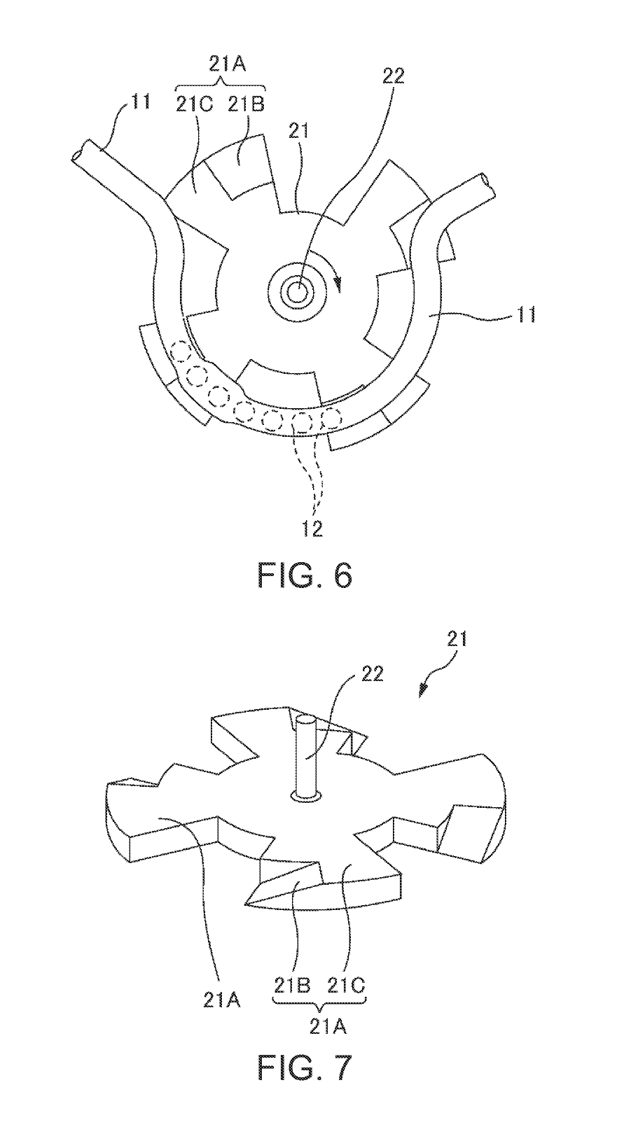

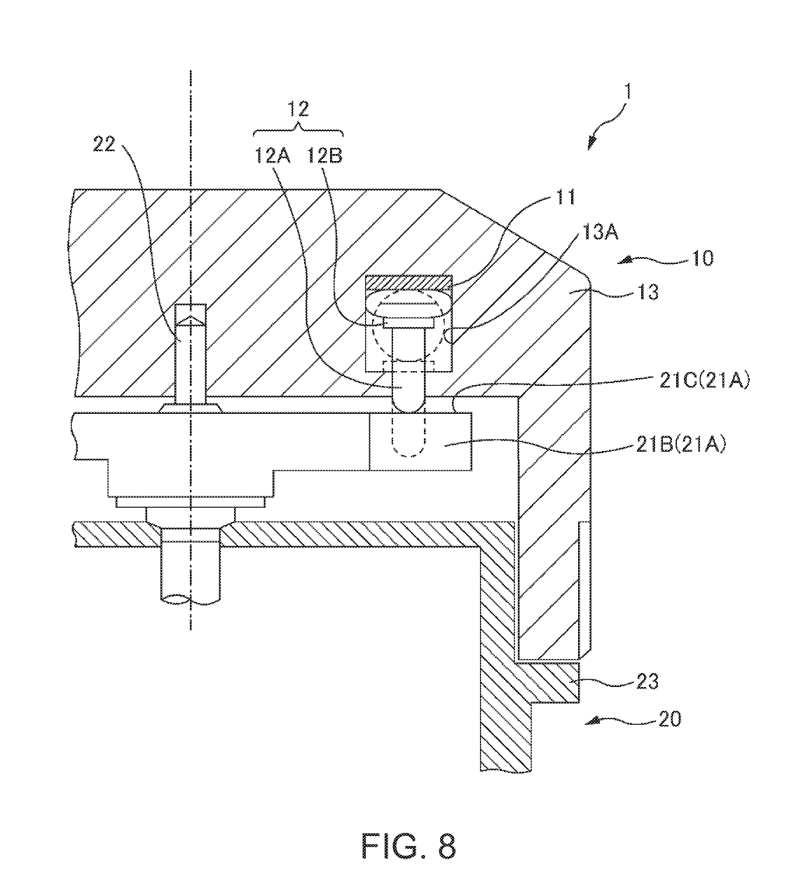

FIG. 6 is a diagram illustrating the arrangement of a cam 21, a tube 11 and fingers 12 according to the second embodiment, taken from above. FIG. 7 is a diagram illustrating the shape of the cam 21 of the second embodiment. FIG. 8 is a diagram illustrating the motion of the fingers 12.

Also in the second embodiment, the tube 11 and the fingers 12 are accommodated in the replacement frame 13 of the replacement unit 10. The cam 21 is provided in the main unit frame 23 of the main unit 20. It should be noted that the cam 21 is not accommodated within the main unit frame 23, but is exposed on the side of the replacement unit 10.

In the first embodiment, the protrusions 21A are formed on the upper surface of a disk-shaped plate member, whereas in the second embodiment, the protrusions 21A are formed on the outer circumference of the disk-shaped plate member. However, as in the first embodiment, the protrusions 21A of the cam 21 of the second embodiment have the function of pressing the fingers 12 upward (in a direction parallel to the rotation shaft 22 of the cam 21).

According to the second embodiment, the thickness of the cam 21 (its dimension in vertical direction) can be made thinner than that of the cam 21 of the first embodiment. Thus, the fluid transport apparatus 1 can be made thinner.

Also in the second embodiment, the footprint (planar size) can be reduced by arranging the tube 11, the fingers 12 and the cam 21 in a layered arrangement in the rotation axis direction of the cam 21 (the direction in which the replacement unit 10 is mounted to the main unit 20). Moreover, also in the second embodiment, if the fingers 12 are supported movably in vertical direction, then the fingers 12 can be moved upward when the fingers 12 are subjected to an upward force from the protrusions 21A of the cam 21 during mounting, and they will not be damaged.

### FURTHER CONSIDERATIONS

The foregoing embodiments have mainly described fluid transport apparatuses, but it goes without saying that they also include the disclosure of a fluid transporting method and a method for manufacturing a fluid transport apparatus (or a replacement unit or main unit).

The foregoing embodiments are merely for facilitating the understanding of the invention and are not meant to limit the invention in any way. It will be appreciated that numerous variations and modifications are possible that do not deviate substantially from the novel aspects and effect of the invention, and those variations, modifications and equivalents are also to be included within the scope of the invention.

The entire disclosure of Japanese Patent Application No. 2012-032461, filed Feb. 17, 2012 is expressly incorporated by reference herein.

What is claimed is:

1. A fluid transport apparatus comprising:
a main unit; and
a replacement unit that is removably attachable to the main unit;
the replacement unit including a tube for transporting a fluid, and a plurality of fingers for pressing against and occluding the tube, the plurality of fingers being arranged along the tube,
the main unit including a cam for pressing the plurality of fingers successively in a transport direction of the fluid, and
the tube, the plurality of fingers and the cam being arranged in a layered arrangement along a rotation axis direction of the cam.

2. The fluid transport apparatus according to claim 1,
wherein the fingers are supported movably along a direction in which the replacement unit is mounted to the main unit.

3. The fluid transport apparatus according to claim 2,
wherein the tube is not occluded before the replacement unit is mounted to the main unit, and
at least one of the fingers is pushed by the cam and occludes the tube when the replacement unit is mounted to the main unit.

4. The fluid transport apparatus according to claim 1,
wherein the main unit is provided with a motor for driving the cam.

5. The fluid transport apparatus according to claim 1,
wherein the replacement unit is provided with a motor for driving the cam.

6. A replacement unit of a fluid transport apparatus, the replacement unit comprising:
a tube for transporting a fluid; and
a plurality of fingers for pressing against and occluding the tube, the plurality of fingers being arranged along the tube;
the replacement unit being removably attachable to a main unit including a cam for pressing the plurality of fingers successively in a transport direction of the fluid, and
the tube and the plurality of fingers being arranged in a layered arrangement along a rotation axis direction of the cam.

7. A method for manufacturing the replacement unit according to claim 6, comprising:
preparing fingers of different lengths;
selecting fingers of a length corresponding to a diameter of the tube; and
using the fingers of the selected length to manufacture the replacement unit.
